(19) United States
(12) Patent Application Publication
(10) Pub. No.: US 2025/0322368 A1
(43) Pub. Date: Oct. 16, 2025

(54) SYSTEM AND METHOD FOR GAUGING ENGAGEMENT LEVEL OF ONLINE GROUP MEMBERS WITH SHARED ELECTRONIC DATA

(71) Applicant: RingCentral, Inc., Belmont, CA (US)

(72) Inventors: Christopher van Rensburg, Portland, OR (US); Martin Arastafar, Redwood City, CA (US)

(21) Appl. No.: 19/248,979

(22) Filed: Jun. 25, 2025

Related U.S. Application Data
(63) Continuation of application No. 17/247,438, filed on Dec. 10, 2020.

(51) Int. Cl. G06Q 10/109; G06F 3/0482; G06Q 30/02

(52) U.S. Cl. CPC G06Q 10/109; G06F 3/0482; G06Q 30/02

(57) ABSTRACT

A method includes monitoring accesses to a plurality of data shared with a plurality of online users that form an online group, wherein the plurality of data is shared over a plurality of times. The method further includes determining statistical information associated with accesses to the plurality of data by the plurality of online users. The method also includes displaying the statistical information in a graphical user interface (GUI).

### RELATED APPLICATIONS

The instant application is a continuation application and claims the benefit and priority to the U.S. application Ser. No. 17/247,438 filed on Dec. 10, 2020, which is incorporated herein by reference in its entirety.

### TECHNICAL FIELD

The present disclosure relates generally to the field of computer supported meeting/conferencing. More specifically, and without limitation, this disclosure relates to systems and methods for automatically determining engagement level of members of an online group with respect to shared electronic content.

### BACKGROUND

Recent advancements in technology and in particular online technology has led to an increased use of online forums to disseminate information. For example, use of various online chat groups, webinars, etc., has become prevalent to share information. In one nonlimiting example, a user of a chat communication service may create an online chat group/team to disseminate information and news updates to the members of that chat group/team.

Unfortunately, there is currently no intelligent way to gauge a level of engagement by group members and to determine how caught up the group members are with respect to content being shared. Moreover, it is often the case that the created group/team is quite large, with members with varying backgrounds. As such, the content being shared may be very relevant to some group members while it may only be minimally relevant to others. As such, some group members may become very active and others may be very inactive in sharing content or in keeping up with the latest updates. For example, some group members may stop visiting or may only infrequently visit the chat group/team to read through the messages, while others may be adamant about being current with respect to the content being shared. Unfortunately, there is currently no intelligent way to gauge and determine the level of engagement by the members and to encourage them to become more active and current, e.g., by sending them reminders. Moreover, there is currently no intelligent mechanism to remove or suggest removal of certain members from the group based on their activity or lack thereof, or suggest adding other members to the group based on their level of activity from other chat groups/teams.

### SUMMARY

Accordingly, a need has arisen to determine a level of engagement, e.g., whether the group members are caught up with the shared information, whether the shared information is being further interacted with by the group members, etc. The level of engagement by the group members may be used to encourage the group members who are not very engaged to become more engaged and to catch up with respect to the shared content. Moreover, a need has arisen to modify the team members of the created group based on their activity and level of engagement with the content being shared. Furthermore, a need has arisen to further identify the level of engagement by members of different departments in an organization within the created group. Individual(s) from each department that are engaged and active may be identified and invited to other online groups/teams based on their activity level, engagement level, etc.

In some embodiments, a method includes monitoring accesses to a first electronic data shared at a first time with a plurality of online users formed as an online group. The method also includes monitoring accesses to a second electronic data shared at a second time with the plurality of online users. In some embodiments, a first subset of online users from the plurality of online users that have accessed the first electronic data is identified. According to some embodiments, a second subset of online users from the plurality of online users that have accessed the second electronic data is determined. Statistical data associated with the first subset of online users and the second subset of online users in a graphical user interface (GUI) is displayed.

In some embodiments, the statistical data includes a number of online users that have accessed the first electronic data and a number of online users that have accessed the second electronic data. According to some embodiments, the method further includes determining a duration of time elapsed between when the first electronic data was shared and when the first electronic data was accessed by each online user of the first subset of online users. In some embodiments, the method may further include displaying data associated with the duration of time elapsed between when the first electronic data was shared and when the first electronic data was accessed by each online user of the first subset of online users. It is appreciated that in some embodiments, the method further includes transmitting a reminder signal to a third subset of online users from the plurality of online users that have not accessed the first electronic data, wherein the reminder signal is transmitted in response to a triggering event. The triggering event may be expiration of a certain time period after the first electronic data has been shared. In some nonlimiting examples, the triggering event is related to a level of importance of the first electronic data.

It is appreciated that in some embodiments, the method may further include identifying a third subset of online users from the plurality of online users as key members associated with the first electronic data based on a content of the first electronic data, assignment associated with the plurality of online users as designated by a creator of the online group, and organizational relationship of the plurality of online users to the creator of the group.

According to some embodiments, the method may further include identifying a fourth subset of online users from the plurality of online users to be removed from the online group based on the statistical data. It is appreciated that the method may include removing a fifth subset of online users from the online group, wherein the fifth subset of online users is a subset of the fourth subset of online users. In some embodiments, the identifying of the fourth subset of online users may be based on importance of online users in the fourth subset of online users in comparison to a remainder of online users of the plurality of online users, level of activity of the fourth subset of online users, and level of interest associated with the fourth subset of online users in content being shared with the online group.

In some embodiments, the method may further include determining a value of the first electronic data based on a pattern associated with the first subset of online users interacting with the first electronic data. It is appreciated that the pattern may be selected based on subsequent sharing of content associated with the first electronic data by the first subset of online users, a number of likes associated with the first electronic data, or a copy/paste of a uniform resource locator (URL) associated with the first electronic data. The URL may be a proxy URL in some nonlimiting examples. It is appreciated that the subsequent sharing of content associated with the first electronic data by the first subset of online users may be through an online chat in another online group. In some embodiments, the subsequent sharing of content associated with the first electronic data by the first subset of online users may be through a voice call or a video call. It is appreciated that the pattern may be determined using a machine learning algorithm to group and cluster actions taken by the first subset of online users with respect to the first electronic data.

In some embodiments, the method may include determining a department associated with each online user of the first subset of online users. It is appreciated that a department associated with each online user of the second subset of online users is determined. In some embodiments, statistical data associated with the first subset of online users and the second subset of online users and respective departments associated therewith is displayed. The method may further include identifying an online user from the first subset of online users for each department based on activity pattern associated with the first electronic data. It is appreciated that in some embodiments, the method may further include identifying an online user from the first subset of online users and the second subset of online users for each department based on activity pattern associated with the first and the second electronic data.

These and other features and aspects of the concepts described herein may be better understood with reference to the following drawings, description, and appended claims.

### BRIEF DESCRIPTION OF DRAWINGS

FIG. 1A is a diagram showing an example of an online user creating an online group/team via an communication system according to some embodiments.

FIG. 1B is a diagram showing an example of online users connecting to an communication system after the online group/team has been created according to some embodiments.

FIG. 2 is a flow chart illustrating an example of method flow for determining whether the members of the online group/team are caught up with the shared content in accordance with some embodiments.

FIG. 3 is a diagram illustrating an exemplary output display associated with the level that members of the online groups are caught up with the shared content according to some embodiments.

FIG. 4 is a flow chart illustrating an example of method flow for identifying key members of the online group/team in accordance with some embodiments.

FIG. 5A is a diagram illustrating an exemplary output display associated with the level that key members and non-key members of the online groups are caught up with the shared content according to some embodiments.

FIG. 5B is a diagram illustrating an exemplary output display associated with the level that key members and non-key members of the online groups are not caught up with the shared content according to some embodiments.

FIG. 6 is a flow chart illustrating an example of method flow for generating reminders for members of the online group/team according to some embodiments.

FIG. 7 is a diagram illustrating an exemplary output display associated with the level that members are caught up with the shared content after transmission of a reminder according to some embodiments.

FIG. 8 is a flow chart illustrating an example of method flow for processing activities by the members of the online group/team according to some embodiments.

FIG. 9 is a diagram illustrating an exemplary output display showing the activities associated with online group/team according to some embodiments.

FIG. 10 is a diagram illustrating an exemplary output display showing the determined department associated with members of the online group/team according to some embodiments.

FIG. 11 is a diagram illustrating an exemplary output display showing the level that the members of each department are caught up with the shared content according to some embodiments.

FIG. 12 is a block diagram depicting an example of computer system suitable for determining the level that members of the online groups are caught up with the shared content in accordance with some embodiments.

### DETAILED DESCRIPTION

The example embodiments described herein are directed to a communication system. The communication system is configured to facilitate communication between online users. Communication may be through an online forum, e.g., online group, online team, webinar, chat team, etc. The communication system may also facilitate communication between users via telephony and/or video conferencing, etc.

The communication system is configured to facilitate data exchanges, e.g., audio data, video data, content data (e.g., PowerPoint®, Word®, PDF, etc.), messaging (e.g., instant messaging), etc., amongst users. It is appreciated that the term “user(s)” generally refers to participants of a communication session whether as host or invitee(s) or team member(s). It is also appreciated that the term “user” is used interchangeably with “member” or “participant” throughout the application.

A host or an administrator or any online user may create an online group/team using the communication system. For example, a user may create an online group or team via a chat function of the communication system. As another example, a user may create an online group for a webinar using the communication system. It is appreciated that the term “group” or “team” has been used interchangeably throughout the application. It is appreciated that terms “host,” “administrator” and “user” may be interchangeable in relation to their roles and/or access privileges to the online group/team. For example, each of them can create the online group/team, manage the online group/team, manage participants of the online group/team, etc.

Once an online team has been created, one or more members of the team can share electronic data/content with other users (i.e. team members). For example, a team member (whether the host or another team member) may post content to share with other team members. It is appreciated that the content may be shared sporadically, as needed. In some examples, the content is shared at regular intervals, e.g., once a week, twice a week, once a month, once a day, etc. It may be desirable to determine the relevance and/or importance of the shared content to the online group. It is appreciated that it may also be desirable to determine whether the team members are caught up with respect to the shared content(s). It is further desirable to determine the level of engagement of the team members with the shared content(s). It is appreciated that throughout the application, references are made to content that may be one or more content shared over a period of time.

In some embodiments, intelligence built into the communication system may be used to determine which group members are caught up with a shared content (i.e. have accessed the shared content) and the time elapsed between when the content was shared and when it was accessed by the group members. In some embodiments, the access to the shared content may be monitored by the communication system. Accessing the shared content may be construed as the member having reviewed the content and being up-to-date with the content being shared. It is appreciated that after determining which group members have accessed the shared content, the information may be presented in statistical format, e.g., a number of group members or percentage of the group members that are up-to-date with respect to a content that was shared a week ago as opposed to two weeks ago, etc. It is further appreciated that the lag time between when a particular content was shared and when it was accessed and reviewed by a member may also be tracked and displayed.

It is appreciated that the information regarding the group members and how up-to-date the group members are with respect to any given shared content can be used to motivate and encourage the members that are not up-to-date to review the shared content. For example, a reminder email(s) may be sent to members that are not up-to-date with respect to a particular shared content. It is appreciated that a determination with respect to the group members being up-to-date may similarly be made after a reminder is sent, e.g., after a day, after a week, etc., to determine whether the group members that were previously not engaged or not caught up with respect to a given shared content have become engaged and are up-to-date after receiving the reminder(s). It is appreciated that subsequent reminder emails may be sent, as desired, until a certain threshold is reached, e.g., certain percentage of the group members are caught up.

According to some embodiments, activities associated with the content being shared may be monitored to determine the importance of a shared content. For example, a number of group members resharing the shared content, a number of likes a shared content has received, a number of pins associated with a shared content, a number of copy/pastes of the shared content or a portion thereof (e.g. into an email or a search bar of a web browser or another message application or another conversation thread in the same message application, etc.), a number of accesses to the uniform resource locator (URL) associated with the shared content, a number of accesses to a proxy URL associated with the shared content, a number of emails having content associated with the shared content, a number or volume of content in other online forums such as other chat groups discussing the shared content, a number of voice calls associated with the shared content, a number of video conferences associated with the shared content, etc., may be used to determine the importance of a given shared content. In other words, activities of the online group members with respect to the shared content may be a reflection of importance of the shared content. For illustrative purposes, a shared content receiving many likes, being discussed in other chat groups, information associated therewith being searched online, and URL being accessed by many group members and/or nongroup members may be construed as the shared content being more important in comparison to a shared content that has received no likes and lack engagement by the members of the online group or other online groups. As an example, the importance of the content can be determined based on a total number of factors that exceeds a threshold. The factors may be actions or utilizations taken by users in relation to the content, that exceed a set threshold. The communication system may automatically set the threshold at 10 for monitoring, for example. In this example, 10 is a total number of actions taken by the users in relation to the content and/or the total number of times the content has been utilized. The users may, for example, give 5 likes to the shared content, copy & paste the shared content to another communication thread 3 times, and search for the shared content 3 times using known search techniques. Since the users have interacted or utilized the shared content 11 times overall, which exceeds the threshold of 10, the system labels the shared content as important content. It should be noted that the threshold can be set by a group creator or another participant manually or based on a suggestion from the communication system.

As a nonlimiting example, each factor (i.e. number of likes, number of discussions in other chat groups, number of searches, etc.) as described above may be given an appropriate weight. In some embodiments, the appropriate weight is used as a multiplier to the number of times the content was utilized by the user(s). For example, the number of likes factor can be assigned a weight of 0.5, the search factor can be assigned a weight of 1 and the copy & paste factor can be assigned a weight of 2. As described in the example above, the threshold is set to 10. Applying the weights to the factors, the shared content from the example above gets 5 likes with a multiplier of 0.5, which provides for a score of 2.5. The shared content also is copied & pasted 3 times with a multiplier of 2, which provides for a score of 6. The shared content also is also searched for 3 times with a multiplier of 1, providing a score of 3. The sum of all the factors calculated based on the assigned weights is 11.5, which exceeds the threshold of 10. Since the importance threshold has been exceeded, the content is determined to be important. The weights can be assigned automatically by the communication system or by the users of the team. In some embodiments, user feedback may be used to adjust the weights and/or threshold. As such, group members that are not up-to-date with respect to a shared content that is determined to be important may be encouraged to review the shared content, e.g., by sending reminder emails. In other words, shared content that is determined to be important is flagged such that the administrator or the host can get more “eyes” on the shared content by group members that are not caught up with the content.

In yet another embodiment, Artificial Intelligence (AI) and Machine Learning (ML) techniques can be used to determine the importance of the shared content. ML techniques can be used to evaluate past data on the various factors or activities (i.e. number of likes, number of discussions, number of searches, etc.) by the users in relation to the shared content. In some embodiments, activities that have historically applied to certain types of shared content, the frequency of the activities in relation to the types of shared content, the circumstances in which the activities occurred, the largest or smallest utilization activity by the users, or any other factor may be data points that are fed into the ML algorithm as training data to determine the importance of the shared content. The AI model may also use live feedback from the users to train and adjust the ML algorithm to more accurately determine the importance of content. For example, the system can request feedback from the users on whether the shared content, which has been determined automatically as important, is indeed important. Based on the user feedback, the ML algorithm can be adjusted or further trained to correctly identify content as important or not important. Additionally, upon determining that a shared content is important, the system may confirm with the users whether the shared content is important before assigning this status or label to the shared content. For example, a pop-up notification may be displayed with two options: “important content” and “not important content”. Based on the user's feedback, the ML algorithm may be further trained to correctly identify important or unimportant content. The ML technique is further described below.

It is appreciated that in some embodiments, the communication system may determine whether each member of the online group is a key member or not a key member with respect to any given shared content. For example, a first subset of members of the online group may be identified as key members with respect to a first shared content whereas a second subset of members of the online group may be identified as key members with respect to a second shared content. It is appreciated that determining whether a member of the online group is a key member or not may be done based on criteria such as organizational relationship of that member to the host or the creator of the online group, the relevance of the shared content to the background and experience of the member, designation of the member as being a key member by the group creator (i.e. “required” when the online team is being created), past behavior of the group members, correlation between the title of the online group and the member's background, correlation between the content being shared and the background of the member, etc.

In some nonlimiting examples, the communication system can set 5 criteria that include: a user's position within an organization, a user's expertise level in a topic of the shared content, a user's current responsibilities related to the shared content, the existence of another communication with similar or related topic to the shared content, and relevance of the shared content to the user's background (e.g. educational background, work experience, etc.) The communication system can set a threshold of 3 out of the 5 criteria that, if met, would identify a user as key member. If the criteria threshold is not met, then the user is determined as a non-key member. For example, if the user has expertise in the shared content, has engaged in other communications with a similar or related topic to the shared content, and has a background related to the shared content, then the communication system can deem the user a key member because 3 of the 5 criteria have been met.

In yet another example, criteria associated with whether a member is a key member or non-key member may be weighted depending on the importance of each criterion. For example, a user's position in an organization may be assigned a weight of 0.5, the user's expertise level in a topic of the shared content may be assigned a weight of 1, the user's current responsibilities related to the shared content may be assigned a weight of 2, the existence of another communication with similar or related topic to the shared content may be assigned a weight of 1, and the relevance of the shared content to the user's background may be assigned a weight of 1.5. Each weight can be used as multiplier for the criteria mentioned above. Once the weighted criteria are calculated, if the final numerical value exceeds a predetermined threshold value, then the member is identified as a key member. If the final numerical value does not exceed the predetermined threshold value, then the member is identified as a non-key member. It should be noted that the criteria and the weights may both be assigned by the user. In another embodiment, one of these parameters is assigned by the user while the other one is assigned by the communication server. Different thresholds can be set for different shared content in different chat groups, in various embodiments. It is appreciated that whether the group members are key members or not may be with respect to a plurality of shared content.

In some embodiments, the information regarding group members that are up-to-date as opposed to not up-to-date can be used to modify the online group members, e.g., remove members that are not engaged. Accordingly, the online group members can be modified such that the shared content is more tailored and more relevant to the group members (i.e. once modified). Accordingly, members that are either not interested or not engaged in the shared content can be removed. Moreover, in some embodiments, the communication system may suggest removing non-key members from the online group or may remove the non-key members automatically.

It is appreciated that the group members may be further analyzed to determine the department or organization with which they are associated. As such, statistical information regarding how up-to-date each department is with respect to a particular shared content can be displayed. Accordingly, the group members from a given department may be modified, as desired. It is further appreciated that statistical information regarding how up-to-date members of each department are with respect to a given shared content can be used in creation of future online groups. For illustrative purposes, a group member from a given department that is identified as being very active and engaged can be invited to participate in other online groups and forums. In other words, the identified members from each department of an online group that are engaged and active are portable to other online groups.

It is appreciated that Machine Learning (ML) and Artificial Intelligence (AI) may be used by the communication system to identify key members, to determine the importance of shared content, to modify group members based on engagement level of the group members, etc. For example, various clustering or pattern recognition algorithms for ML can be used to identify key members based on clustering (e.g. organizational relationship of a member to the host, relevance of the shared content to a member's background and prior interactions in other online groups, designation of members as being key members by the online group creator/host, prior behavior of the members, correlation between the title of the online group and members' backgrounds, correlation between the content being shared and the background of the members, etc.). Additionally, various clustering or pattern recognition algorithms for ML can be used to determine the importance level of a shared content based on the group members' activities and interactions associated with the shared content (e.g. a number of group members resharing the shared content, a number of likes a shared content has received, a number of pins associated with a shared content, a number of copy/pastes of the shared content or a portion thereof (e.g. into an email or a search bar of a web browser, etc.), a number of accesses to the uniform resource locator (URL) associated with the shared content, a number of accesses to a proxy URL associated with the shared content, a number of emails having content associated with the shared content, a number or volume of content in other online forums such as other chat groups discussing the shared content, a number of voice calls associated with the shared content, a number of video conferences associated with the shared content, etc.). It is appreciated that ML algorithm may further be used to identify members to be removed from the online group and members to be added to the online group based on their engagement and/or activity level. Moreover, ML algorithms may be used to cluster and group identified group members from different departments and to predict their level of engagement and activity in other online groups, thereby suggesting whether or not any given group member from a particular department should be invited to another online group. It is appreciated that the ML algorithm may be supervised or unsupervised.

It is appreciated that a neural network may use an input layer, one or more hidden layers, and an output layer to train the ML algorithm to identify key members, to determine the importance level of the shared content, to identify members to be removed, and to identify members from different departments and to predict their level of engagement and activity. In some nonlimiting examples, supervised learning may be used for circumstances where members identified as key members are confirmed, and/or where the shared content identified as important is confirmed, and/or where members identified to be removed are confirmed, and/or members from different departments identified based their level of engagement are confirmed. For supervised learning, known input data may be used to gradually adjust the model to more accurately compute the already known output. Once the model is trained, field data is applied as input to the model and a predicted output is generated.

In other embodiments, unstructured learning may be used when supervised learning is unavailable. Training of the neural network using one or more training input matrices, a weight matrix, and one or more known outputs is initiated by one or more computers associated with the online chat system. In an embodiment, a server may run known input data through a deep neural network in an attempt to compute a particular known output. For example, a server uses a first training input matrix and a default weight matrix to compute an output. If the output of the deep neural network does not match the corresponding known output of the first training input matrix, the server adjusts the weight matrix, such as by using stochastic gradient descent, to slowly adjust the weight matrix over time. The server computer then re-computes another output from the deep neural network with the input training matrix and the adjusted weight matrix. This process continues until the computer output matches the corresponding known output. The server computer then repeats this process for each training input dataset until a fully trained model is generated.

In some embodiments, the input layer includes a plurality of training datasets that are stored as a plurality of training input matrices in a database associated with the communication system. The training input data includes, for example, organizational relationship of a member to the host, relevance of the shared content to a member's background and prior interactions in other online groups, designation of members as being key members by the online group creator/host, prior behavior of the members, correlation between the title of the online group and members' backgrounds, correlation between the content being shared and the background of the members, a number of group members resharing the shared content, a number of likes a shared content has received, a number of pins associated with a shared content, a number of copy/pastes of the shared content or a portion thereof (e.g. into an email or a search bar of a web browser, etc.), a number of accesses to the uniform resource locator (URL) associated with the shared content, a number of accesses to a proxy URL associated with the shared content, a number of emails having content associated with the shared content, a number or volume of content in other online forums such as other chat groups discussing the shared content, a number of voice calls associated with the shared content, a number of video conferences associated with the shared content, level of engagement and/or activity, group members from different departments and their level of engagement and activity in other online groups, etc. Any type of input data can be used to train the model.

It is appreciated that the hidden layers represent various computational nodes that represent weighted relationships based on the weight matrix. It is appreciated that the weight of each line may be adjusted overtime as the model is trained. It is appreciated that any number of hidden layers may be used. The output layer may be the identification of members as key members, the content as important content, the members to be removed, the members from different departments identified based on their level of engagement, etc., are known output. It is appreciated that in a structured model, the appropriate designation of members as key members, content as important content, members as members to be remove, members from different departments based on their level of engagement, etc., may be used as a target output for continuously adjusting the weighted relationships of the model. When the model successfully outputs the appropriate output, then the model has been trained and may be used to process live or field data.

Once the neural network is trained, the trained model will accept field data at the input layer. In some embodiments, the field data is live data that is accumulated in real time. In other embodiments, the field data may be current data that has been saved in an associated database. The trained model is applied to the field data in order to generate one or more appropriate output, e.g., identifying key members, importance of shared content, etc.

Before various example embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying,” “rendering,” “utilizing,” “launching,” “calling,” “starting,” “accessing,” “sending,” “conferencing,” “triggering,” “ending,” “suspending,” “terminating,” “monitoring,” “displaying,” “removing”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

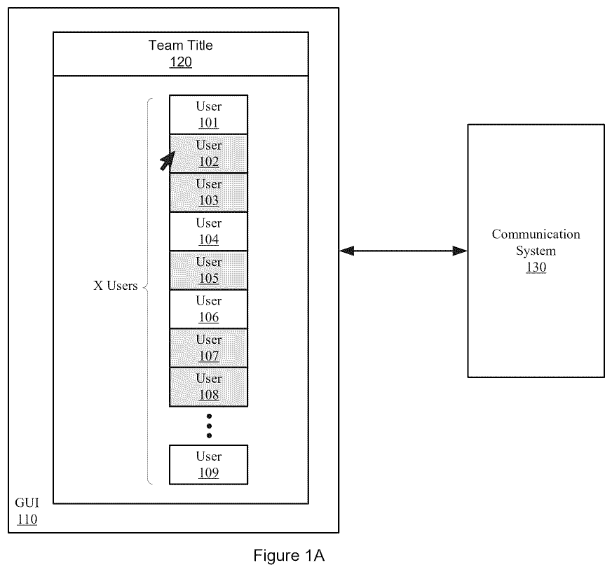

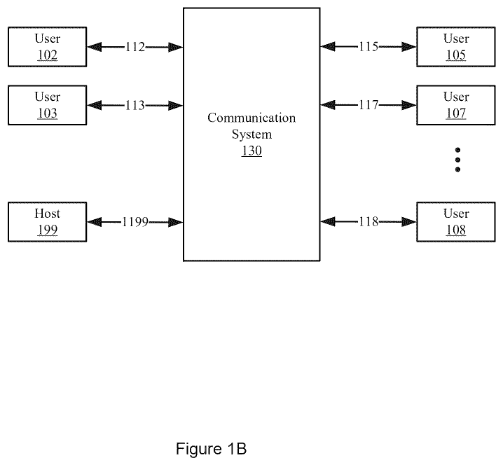

FIG. 1A is a diagram showing an example of an online user creating an online group/team via a communication system 130 according to some embodiments. It is appreciated that the communication system 130 may be used to create an online group/team where the communication system 130 facilitates communication among different members of the group/team. The communication may facilitate a chat, a video conference, an audio call, a webinar, etc., among the team members. Accordingly, the group members may exchange data/content, e.g., audio data, video data, content data (e.g., PowerPoint®, Word®, PDF, etc.), messaging (e.g., instant messaging), etc.

A host or an administrator or any online user may create an online group/team using the communication system 130. For example, a host may enter a team title in the team title 120 field of a graphical user interface (GUI) 110. The host may select users 102, 103, 105, 107, and 108 from users (X number of users, e.g., 101, 102, 103, 104, 105, 106, 107, 108, . . . , 109) to form the online group/team. The online group/team may be a chat team or webinar or a team for videoconferencing as illustrative examples. The selected users may be transmitted to the communication system 130 to form the online group/team.

FIG. 1B is a diagram showing an example of online users connecting to a

communication system 130 after the online group/team has been created according to some embodiments. The communication system 130 forms the online group/team and enables the members of the online group to communicate among one another (i.e. electronic communication such as videoconferencing, chat, document sharing, etc.). For illustrative purposes that should not be construed as limiting the scope of the embodiments, a team member (whether the host or another team member) may post content to share with other team members. For example, any user of the online group (i.e. users 102, 103, 105, 107, . . . , 108, host 199) may post or communicate data with other members of the group. It is appreciated that user 102 may communicate content 112 to other members of the online group using the communication system 130. Similarly user 103 may communicate content 113 to other members of the online group using the communication system 130. User 105 may communicate content 115 to other members of the online group using the communication system 130. User 107 may communicate content 117 to other members of the online group using the communication system 130. User 108 may communicate content 118 to other members of the online group using the communication system 130. It is appreciated that the host 199 may communicate content 1199 to other members of the online group using the communication system 130. In one nonlimiting example, users may post content. It is appreciated that the content may be shared sporadically or at a regular interval, e.g., once a week, twice a week, once a month, once a day, etc. In other words, various contents are being posted or shared among the members of the online group over time.

As described above, it may be desirable to determine the relevance and/or importance of the shared content to the online group and how up-to-date the team members are with respect to the content being shared. It is further desirable to determine the level of engagement of the team members with the shared content.

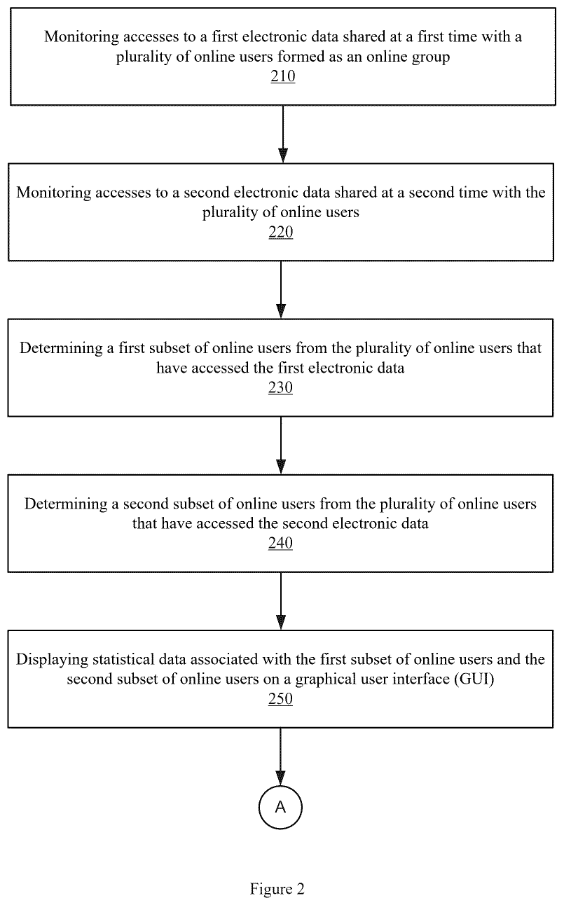

FIG. 2 is a flow chart illustrating an example of method flow for determining whether the members of the online group/team are caught up with the shared content in accordance with some embodiments. It is appreciated that once the online team has been created, the communication system 130 may monitor accesses to the shared content by the group members. It is appreciated that various content may be posted/shared over time. For example, a first content may be shared at a first time, a second content may be shared at a second time, etc. For illustrative purposes, at step 210, accesses to a first electronic data being shared at a first time with the online group members/users that constitute the online group is monitored. For example, a first content may be shared on Monday at 8 a.m. with the group members. Similarly, accesses to other content being shared at another time is also monitored. For example, at step 220, accesses to a second electronic data being shared, e.g., a second content, at a second time with the online group members/users. For example, a second content may be shared on Monday at 8 a.m. a week after the first content was shared. It is appreciated that contents may be shared on a weekly basis for illustrative purposes and not intended to limit the scope of the embodiments. For example, content may be shared daily, monthly, sporadically, etc. It is appreciated that access to content may be construed as the group member being up-to-date or caught up with the shared content.

At step 230, a first subset of online users from the plurality of online users that have accessed the first electronic data is identified. At step 240, a second subset of online users from the plurality of online users that have accessed the second electronic data is identified. It is appreciated that the first and the second subset of online users may be exclusive of one another or may have an overlap of users. It is appreciated that the determined subset of online users may be represented by a numerical value, e.g., 5 users, 7 users, etc., or it may be represented statistically, e.g., 42%, 73%, etc. It is appreciated that at step 250, statistical data associated with the first subset of online users and the second subset of online users is displayed in a GUI. For example, the display may indicate that 12 users have accessed and are caught up with the first content whereas just 5 users have accessed and are caught up with the second content. In some nonlimiting examples, the statistical data may be displayed as a percentage, e.g., 27% of users are caught up with the first electronic data whereas just 12% of users are caught up with the second electronic data. It is appreciated that the determining at steps 230 and 240 may occur at any point after each respective content is shared. It is appreciated that the displaying at step 250 may occur after the determination in steps 230 and 240.

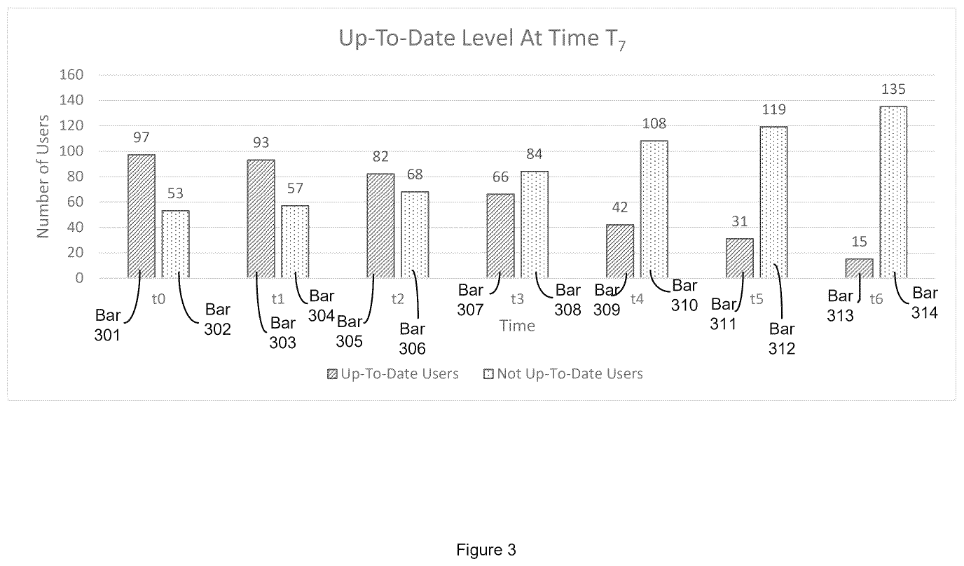

FIG. 3 is a diagram illustrating an exemplary output display associated with the level that members of the online groups are caught up with the shared content according to some embodiments. In this nonlimiting example, a first content is shared at time t₀, a second content is shared at time t₁, a third content is shared at time t₂, a fourth content is shared at time t₃, a fifth content is shared at time t₄, a sixth content is shared at time t₅, and a seventh content is shared at time t₆. In this nonlimiting example, the number of group members of the online group is 150. It is appreciated that the determination of whether the members are caught up with each respective shared content is determined at time t₇. It is determined that at time t₇ bar 301 illustrates that 97 members/users of the online group are up-to-date with respect to the first content, bar 303 illustrates that 93 members/users of the online group are up-to-date with respect to the second content, bar 305 illustrates that 82 members/users of the online group are up-to-date with respect to the third content, bar 307 illustrates that 66 members/users of the online group are up-to-date with respect to the fourth content, bar 309 illustrates that 42 members/users of the online group are up-to-date with respect to the fifth content, bar 311 illustrates that 31 members/users of the online group are up-to-date with respect to the sixth content, and bar 313 illustrates that 15 members/users of the online group are up-to-date with respect to the seventh content. In contrast, bars 302, 304, 306, 308, 310, 312, and 314 illustrate the member/users of the online group that are not up-to-date. As illustrated, the fact that more users/members are caught up with older content may be a function of time whereas more recent content may have not been reviewed by most members. It is appreciated that the GUI may similarly display the number of users/members that are not caught up with each respective content. It is further appreciated that the number of users may be replaced with other statistical formats, e.g., percentage, medium, median, spread, etc. Moreover, it is appreciated that a host or any online user may interact with the displayed GUI to further drill down on each information rendered to gather additional information. For example, an online user may select the bar graph representing 97 users being up-to-date to further break down and obtain names of the group members associated therewith. Moreover, a plurality of GUI buttons may be provided and manipulated to derive additional information. For example, a GUI button may be provided that, once selected, may display the users that are common between two or more content being shared (e.g., users that are caught up and are common between content being shared at t₀ and t₄ as an example). Accordingly, the intelligence built into the communication system 130 may be used to determine which group members are caught up with a shared content (i.e. have accessed the shared content). It is appreciated that in some embodiments, access to a breakdown of users who are up-to-date with respect to the shared content may be given to an organizer (a person who actually created an online team/group) while in other embodiments access to the breakdown information may be given to users with certain organizational position, in another embodiment access to the breakdown information may be given to key members, and yet in other embodiments the breakdown of users and information associated therewith may be accessible to any of the users.

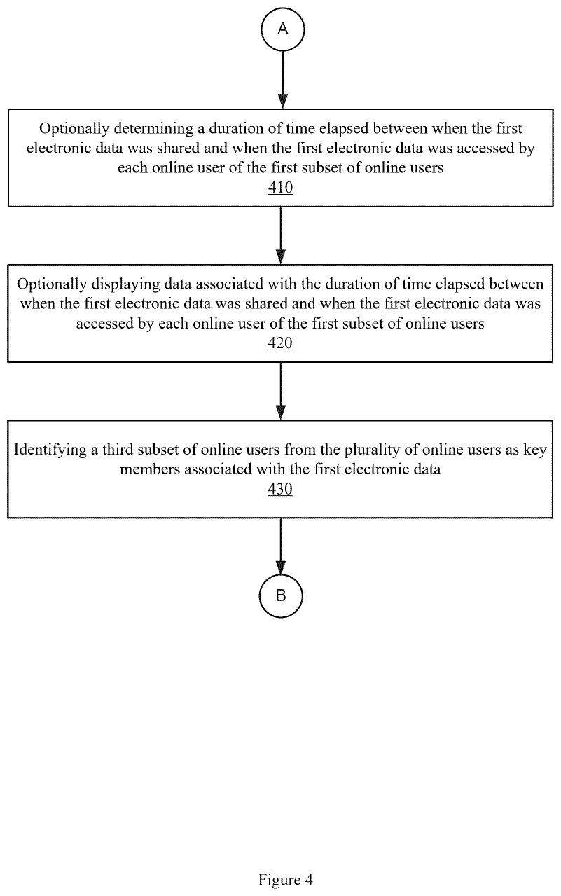

FIG. 4 is a flow chart illustrating an example of method flow for identifying key members of the online group/team in accordance with some embodiments. It is appreciated that FIG. 4 may be a continuation of flow diagram in FIG. 2. Optionally at step 410, a duration of time elapsed between when the first electronic data was shared and when the first electronic data was accessed by each online user of the first subset of online users is determined. For example, a lag time between when the first content, e.g., posted at time t₀, and when it was accessed by each group member may be determined, e.g., 23 users may have accessed it between time t₀ and t₁, while 15 users may have accessed it at time t₁, whereas 27 users may have accessed it between times t₁ and t₂, and so forth. It is, however, appreciated that the lag time may be determined as an exact time as opposed to the period that access may have fallen on. Optionally at step 420, the determined duration of the time elapsed may be displayed in a GUI. It is appreciated that in some nonlimiting examples, at step 430, a third subset of online users is identified as key members, using ML in some example embodiments. It is appreciated that whether a member is a key member may be determined based on each shared content, e.g., content shared at time t₀, content shared at time t₁, etc., or collection of shared contents, e.g., content shared at time t₀ and t₁ and t₄, as an example. In some embodiments, it is appreciated that the first subset of members of the online group may be identified as key members with respect to a first shared content whereas a second subset of members of the online group may be identified as key members with respect to a second shared content. It is appreciated that there may or may not be an overlap between the two subsets of online users identified as key members.

It is appreciated that whether an online user is a key member depends on various factors. For example, whether an online user is a key member for a given online group may be based on organizational relationship of that member to the host or the creator of the online group, e.g., an online user being a direct report of the group creator may be a strong indication that the online user is a key member whereas an online user being in a different department and having never collaborated on any project with the group creator may be a strong indication that the online user is not a key member. It is appreciated that a host or administrator may delegate responsibility of creating a team to a creator. In some embodiments, whether an online user is a key member or not may be further processed and evaluated based on the relevance of the shared content to the background and experience of the member, e.g., the content being shared has a strong correlation with the background of the online user (i.e. similar field of work). In one nonlimiting example, whether an online user is a key member or not may be based on a designation of the member as being a key member by the group creator (i.e. “required” when the online team is being created). In some nonlimiting examples, an online user may be determined to be a key members based on the user's past behavior, e.g., if the online user has kept up with the content and has been engaged with other groups and active in sharing content, then that could be a strong indication that the user is a key member. In some nonlimiting examples, correlation between the title of the online group and the background of the online member may be used to determine whether the online member is a key member. Similarly, correlation between the content being shared and the background of the group member may be used to determine whether the online user is a key member, e.g., a strong correlation between the content being shared and the job description and/or background of the online user may be indicative of the fact that the online user is a key member. It is appreciated that the determination of key members and whether the members are caught up with the shared content may be displayed in a GUI. It is appreciated that an ML algorithm, as described above, may be used to determine whether a user is a key member or non-key member.

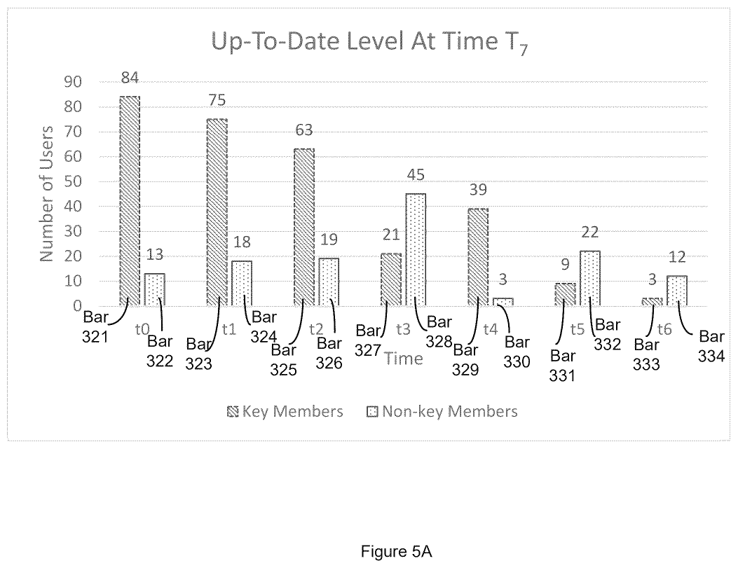

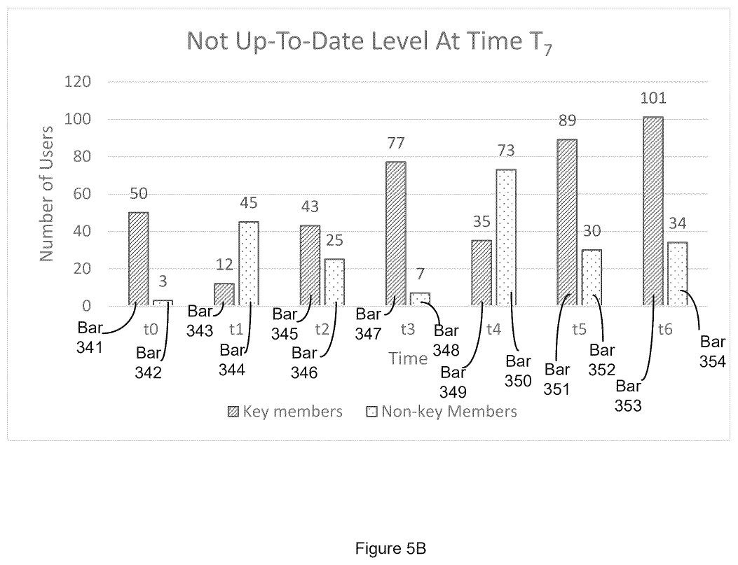

FIG. 5A is a diagram illustrating an exemplary output display associated with the level that key members and non-key members of the online groups are caught up with the shared content according to some embodiments. It is appreciated that non-key members may be members of the group other than the identified key members. FIG. 5A is a GUI displaying the key members versus non-key members that are caught up with content shared at t₀, t₁, t₂, . . . , t₆, for illustrative purposes. In this example, bar 321 illustrates that 84 of the 97 users that are caught up with content shared at time t₀ are identified as key members while bar 322 illustrates that 13 are non-key members. Similarly, bar 323 illustrates that 75 of the 97 users that are caught up with content shared at time t₁ are identified as key members while bar 324 illustrates that 18 are non-key members. Similarly, bar 325 illustrates that 63 of the 82 users that are caught up with content shared at time t₂ are identified as key members while bar 326 illustrates that 19 are non-key members. Similarly, bar 327 illustrates that 21 of the 66 users that are caught up with content shared at time t₃ are identified as key members while bar 328 illustrates that 45 are non-key members. Similarly, bar 329 illustrates that 39 of the 42 users that are caught up with content shared at time t₄ are identified as key members while bar 330 illustrates that 3 are non-key members. Similarly, bar 331 illustrates that 9 of the 31 users that are caught up with content shared at time t₅ are identified as key members while bar 332 illustrates that 22 are non-key members. Similarly, bar 333 illustrates that 3 of the 15 users that are caught up with content shared at time t₆ are identified as key members while bar 334 illustrates that 12 are non-key members. It is appreciated that a pattern may emerge indicative of the fact that perhaps the content shared at time t₀, t₁, t₂, and t₄ are more aligned with the interests of the key members whereas content shared at time t₃, t₅, and t₆ are more aligned with the interests of the non-key members.

FIG. 5B is a diagram illustrating an exemplary output display associated with the level that key members versus non-key members of the online groups are not caught up with the shared content according to some embodiments. In other words, FIG. 5B displays complementary information with respect to FIG. 5A that is directed to caught up members. In this nonlimiting example, bar 341 illustrates that 50 out of 53 members that have not accessed content shared at time t₀ (i.e. are not up-to-date) are key members, bar 343 illustrates that 12 out of 57 members that have not accessed content shared at time t₁ (i.e. are not up-to-date) are key members, bar 345 illustrates that 43 out of 68 members that have not accessed content shared at time t₂ (i.e. are not up-to-date) are key members, bar 347 illustrates that 77 out of 84 members that have not accessed content shared at time t₃ (i.e. are not up-to-date) are key members, bar 349 illustrates that 35 out of 108 members that have not accessed content shared at time t₄ (i.e. are not up-to-date) are key members, bar 351 illustrates that 89 out of 119 members that have not accessed content shared at time t₅ (i.e. are not up-to-date) are key members, and bar 353 illustrates that 101 out of 135 members that have not accessed content shared at time t₆ (i.e. are not up-to-date) are key members. In contrast, bars 342, 344, 346, 348, 350, 352, and 354 illustrate the non-key members that are not up-to-date. As illustrated, a pattern may emerge indicative of the fact that the number of members that are caught up with shared content is reduced closer to when a shared content has been shared. Moreover, as illustrated, a pattern may emerge to indicate that certain members are not caught up with the content even as the shared content ages. It is appreciated that the information regarding the group members and how up-to-date the group members are with respect to any given shared content can be used to motivate and encourage the members that are not up-to-date to review the shared content. For example, a reminder email(s) may be sent to members that are not up-to-date with respect to a particular shared content. It is appreciated that a determination with respect to the group members being up-to-date may similarly be made after a reminder is sent, e.g., after a day, after a week, etc., to determine whether the group members who were previously not engaged or not caught up with respect to a given shared content have become engaged and are up-to-date after receiving the reminder(s). It is appreciated that subsequent reminder emails may be sent, as desired, until a certain threshold is reached with respect to members being up-to-date, e.g., a certain minimum percentage of the group members are caught up on the content shared to the online group/team.

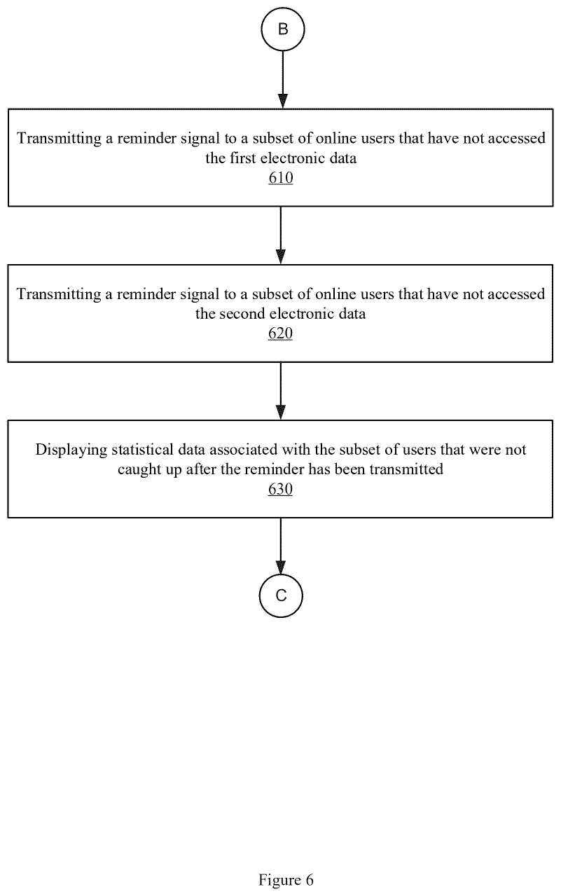

FIG. 6 is a flow chart illustrating an example of method flow for generating reminders for members of the online group/team according to some embodiments. At step 610, a reminder signal is transmitted to a subset of online users that have not accessed the first electronic data (i.e. are not caught up). It is appreciated that subset of users that are not caught up are users other than the ones that are caught up. It is appreciated that the reminder signal may be an email, a chat text, automated phone call, a calendar invite, etc. At step 620, a reminder signal is transmitted to a subset of online users that have not accessed the second electronic data (i.e. are not caught up). It is appreciated that steps 610 and 620 may be repeated for each content that has been shared until a certain threshold is reached with respect to members being up-to-date, e.g., a certain percentage of the online users, such as 80%, are caught up, etc. It is appreciated that the reminder signal may be transmitted in response to a triggering event, e.g., certain period of time elapsing from the time that the content has been shared, importance of the content being shared exceeding some importance threshold, etc.

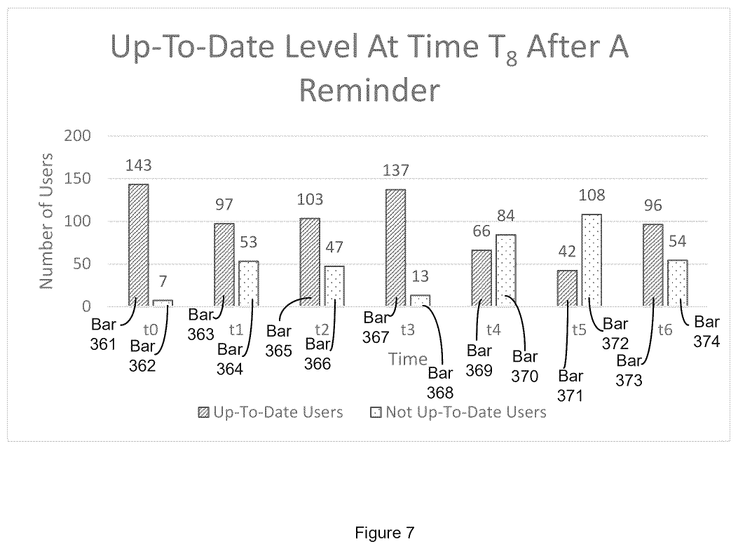

FIG. 7 is a diagram illustrating an exemplary output display associated with the level that members are caught up with the shared content after transmission of a reminder according to some embodiments. In this nonlimiting example, bar 361 illustrates that 143 of the online users are caught up at time t₈ out of 150 for the shared content at t₀ after a reminder is sent. It is appreciated that similar information may be determined and displayed with respect to other shared content. For example, bar 363 illustrates that 97 members are caught up for the shared content at t₁, bar 365 illustrates that 103 members are caught up for the shared content at t₂, bar 367 illustrates that 137 members are caught up for the shared content at t₃, bar 369 illustrates that 66 members are caught up for the shared content at t₄, bar 371 illustrates that 42 members are caught up for the shared content at t₅, and bar 373 illustrates that 96 members are caught up for the shared content at t₆. In contrast, bars 362, 364, 366, 368, 370, 372, and 374 illustrate the members that are not up-to-date after a reminder is sent.

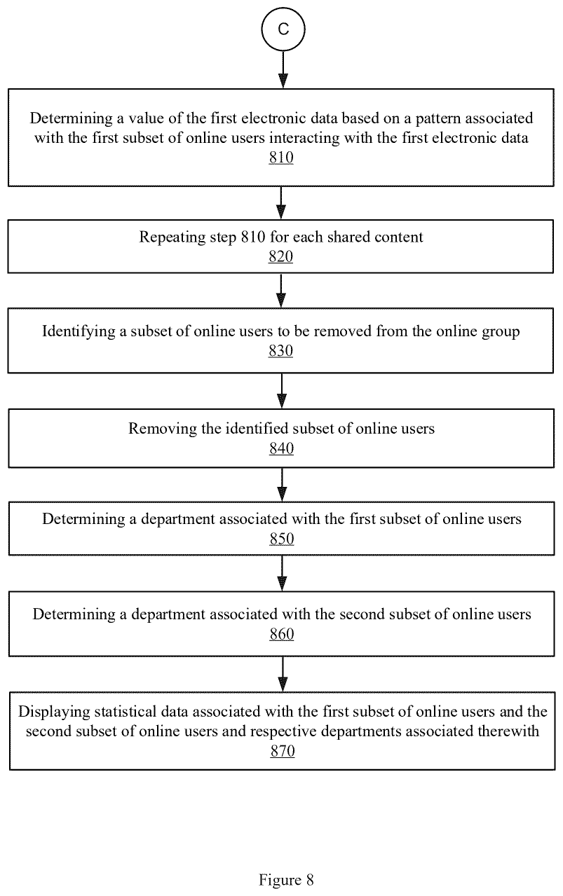

It is appreciated that in some embodiments, activities associated with the content being shared may be monitored to determine the importance of a shared content. FIG. 8 is a flow chart illustrating an example of method flow for processing activities by the members of the online group/team according to some embodiments. It is appreciated that in some optional examples, at step 810 a value of the first electronic data is determined. It is appreciated that the value (i.e. importance) may be determined based on a pattern associated with the first subset of online users from the group interacting with the first electronic data. For example, a number of group members resharing the shared content (with the same group members and/or other online groups) may be an indication that the content is important. A number of likes a shared content has received may also reflect its importance and higher value. A number of pins associated with a shared content may also reflect the higher value and importance since the online user intends to return back to the shared content. In some nonlimiting examples, the interaction between each member and the shared content may be monitored, e.g., a number of copy/pastes of the shared content or a portion thereof (e.g. into an email or a search bar of a web browser, etc.), a number of accesses to the uniform resource locator (URL) associated with the shared content, a number of accesses to a proxy URL associated with the shared content, a number of emails having content associated with the shared content, etc., and, as such, importance of the shared content may be determined based on a combination of the above described factors. Moreover, in some nonlimiting examples, a number or volume of content in other online forums, such as other chat groups discussing the shared content, may be a reflection of importance of the shared content to other groups as well. Following a content being shared, a number of voice calls or video conferences may ensue that may be an indication of the importance of the shared content. In other words, activities of the online group members with respect to the shared content may be a reflection of importance of the shared content. In another example embodiment, only key member activities on the content being shared is taken into consideration. A key member's activity threshold can be set up to determine the importance of the content being shared. For example, when 50%, 60%, or any other percent of key members take any action described above in relation to the content being shared, then the content is determined to be important. The key members activity threshold can be set automatically by the communication system 130, by the host, by the administrator, or by the creator. Accordingly, content that is determined to be important may be flagged and members that are not caught up with that content may be encouraged to get up-to-date, e.g., by sending reminder signals such as an email. As such, shared content that is deemed important gets more “eyes” on it, benefitting the group as whole. It is appreciated that at step 820, step 810 is repeated for each shared content or a subset thereof.

At step 830, a subset of the online users to be removed from the online group may be identified. In some embodiments, the information regarding group members that are up-to-date as opposed to not up-to-date can be used to modify the online group members, e.g., identify members to be removed based on engagement level, “how” up-to-date the members are (i.e. statistical data as discussed in FIGS. 2-5B), whether they are key members or not, etc. Accordingly, the online group members can be modified such that the shared content is more tailored and more relevant to the group members (i.e. once modified). At step 840, the identified members to be removed are actually removed. In some embodiments, the removal may occur once the group creator confirms that the identified members should be removed and/or in response to confirmation from the identified members themselves. It is appreciated that in some embodiments, the identified members to be removed are automatically removed by the communication system 130. Accordingly, members that are either not interested or not engaged in the shared content can be removed.

It is appreciated that the group members may be further analyzed to determine the department or organization with which they are associated. As such, statistical information regarding how up-to-date each department is with respect to a particular shared content can be displayed. Accordingly, the group members from a given department may be modified, as desired. It is further appreciated that statistical information regarding how up-to-date members of each department are with respect to a given shared content can be used in creation of future online groups. For illustrative purposes, a group member from a given department that is identified as being very active and engaged can be invited to participate in other online groups and forums. In other words, the identified members from each department of an online group that are engaged and active are portable to other online groups.

At step 850, a department associated with the first subset of online users (i.e. users that have accessed the first electronic data) is determined. Similarly, at step 860, a department associated with the second subset of online users (i.e. users that have accessed the second electronic data) is determined. It is appreciated that the process may be repeated for each shared content. According to some embodiments, at step 870, statistical data associated with the first and the second subset of online users and their respective departments may be displayed in a GUI. It is appreciated that at least one member from each department may be identified based on the member's level of engagement, activity, etc. As such, the identified member may be recommended to be included into other online groups in order to facilitate a more engaged and active online group outcome.

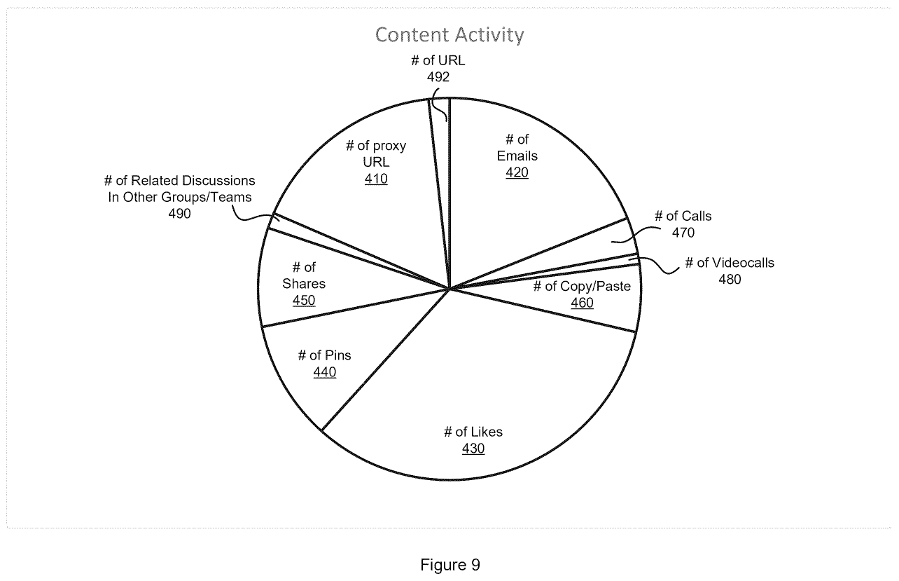

FIG. 9 is a diagram illustrating an exemplary output display showing the activities associated with the online group/team according to some embodiments. In this GUI example, various activities associated with a particular shared content, e.g., content shared at time to, may be represented as a pie chart that may be used in determining the importance of a shared content, as described above. For example, the pie chart may include the number of proxy URL 410 accesses associated with the shared content, the number of emails 420 associated with the shared content, the number of likes 430 associated with the shared content, the number of pins 440 associated with the shared content, the number of shares 450 associated with the shared content, the number of copy/pastes 460 associated with the shared content, the number of calls 470 associated with the shared content, the number of videocalls 480 associated with the shared content, the number of related discussions in other groups/teams 490 associated with the shared content, and the number of URL 492 accesses associated with the shared content.

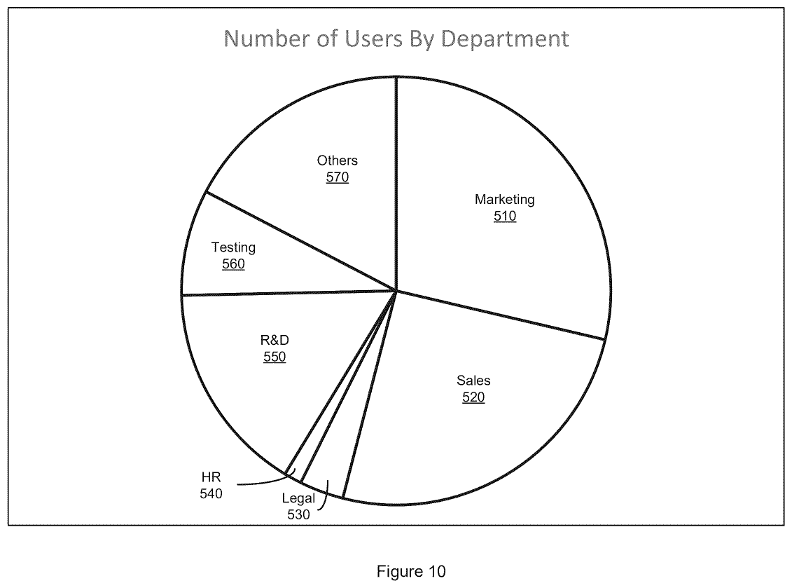

FIG. 10 is a diagram illustrating an exemplary output display showing the determined department associated with members of the online group/team according to some embodiments. In this nonlimiting example, the breakdown of the members by their respective departments is illustrated. For example, 43 out of 150 members may belong to the marketing 510 department, 38 out of 150 members may belong to the sales 520 department, 5 out of 150 may belong to the legal 530 department, 2 out of 150 members may belong to the HR 540 department, 24 out of 150 may belong to the R&D 550 department, 12 out of 150 members may belong to the testing 560 department, while the rest (i.e. 26) of the members are grouped as others 570 in the displayed pie chart. It is appreciated that the GUI is displayed similar to others in FIGS. 3, 5A-5B, 7, and 9, and enables the user or the host to obtain further information. For example, selecting a particular sector of the pie chart may identify individuals within each department and information associated with the level of engagement, activity, and how up-to-date each member is with respect to a given shared content.

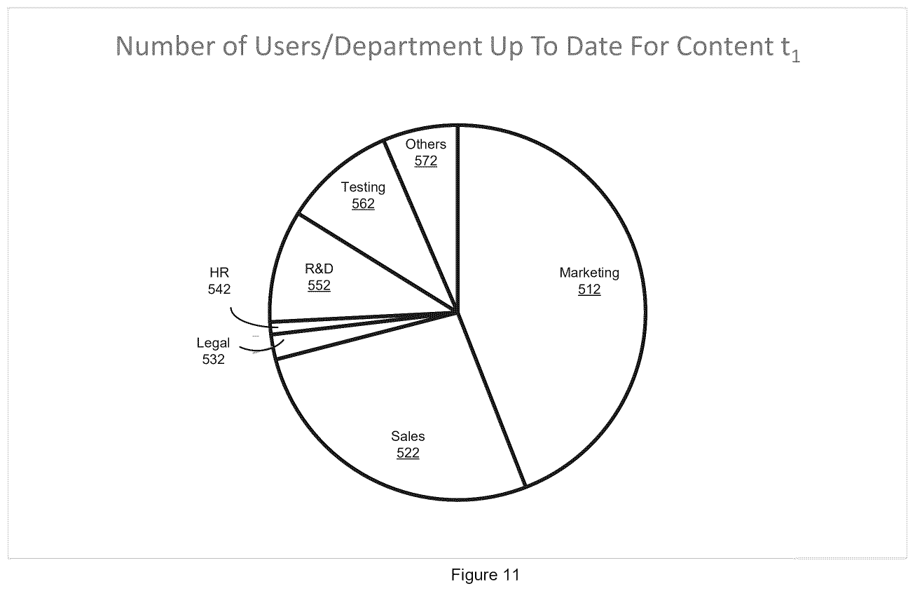

FIG. 11 is a diagram illustrating an exemplary output display showing the determined department associated with members of the online group/team according to some embodiments. In this nonlimiting example, number of users/members that are caught up with the content shared at time t₁ is displayed in a GUI as a pie chart. In this example, 41 of the 93 members that are caught up with the shared content at time t₁ are from the marketing 512 department, while 25 are from the sales 522 department, 2 are from the legal 532 department, 1 is from the HR 542 department, 9 are from the R&D 552 department, 9 are from the testing 562 group, and the remainder (i.e. 6) are from other 572 departments.

It is appreciated that ML and AI may be used by the communication system 130 for various pattern identification, clustering, etc. For example, ML algorithms may be leveraged to identify key members, to determine the importance of shared content, to modify group members based on engagement level of the group members, to identify members from different departments and to predict their level of engagement and activity in other online groups, to suggest certain members to be invited to another online group, etc.

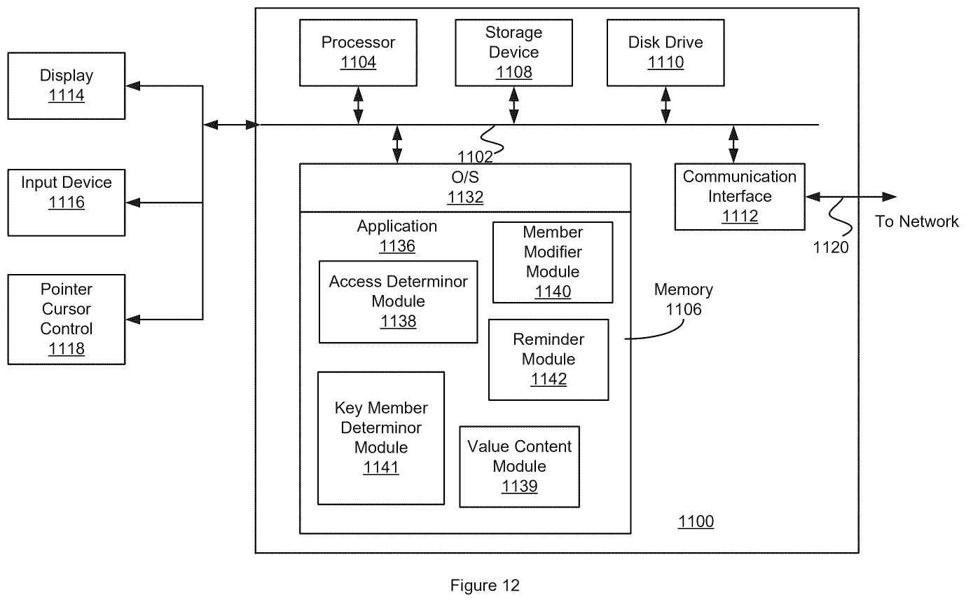

Referring now to FIG. 12, an exemplary block diagram of a computer system suitable for determining the level that members of the online groups are caught up with the shared content in accordance with some embodiments is shown. In some examples, computer system 1100 can be used to implement computer programs, applications, methods, processes, or other software to perform the above-described techniques and to realize the structures described herein. Computer system 1100 includes a bus 1102 or other communication mechanism for communicating information, which interconnects subsystems and devices, such as a processor 1104, a system memory (“memory”) 1106, a storage device 1108 (e.g., ROM), a disk drive 1110 (e.g., magnetic or optical), a communication interface 1112 (e.g., modem or Ethernet card), a display 1114 (e.g., CRT or LCD), an input device 1116 (e.g., keyboard), and a pointer cursor control 1118 (e.g., mouse or trackball). In one embodiment, pointer cursor control 1118 invokes one or more commands that, at least in part, modify the rules stored, for example in memory 1106, to define the electronic message preview process.

According to some examples, computer system 1100 performs specific operations in which processor 1104 executes one or more sequences of one or more instructions stored in system memory 1106. Such instructions can be read into system memory 1106 from another computer readable medium, such as static storage device 1108 or disk drive 1110. In some examples, hard-wired circuitry can be used in place of or in combination with software instructions for implementation. In the example shown, system memory 1106 includes modules of executable instructions for implementing an operating system (“OS”) 1132, an application 1136 (e.g., a host, server, web services-based, distributed (i.e., enterprise) application programming interface (“API”), program, procedure or others). Further, application 1136 includes a module of executable instructions for access determiner module 1138 that determines whether a particular content has been accessed by each respective member of the online group, key member determiner module 1141 to determine whether a member is a key member or non-key member of the online group, content value determiner module 1139 that determines the importance of a content, member modifier module 1140 to identify modifications to be made to the composition of the online group, and a reminder module 1142 to generate and transmit a reminder signal to encourage members that are not caught up with certain content to catch up.

The term “computer readable medium” refers, at least in one embodiment, to any medium that participates in providing instructions to processor 1104 for execution. Such a medium can take many forms, including but not limited to, non-volatile media, volatile media, and transmission media. Non-volatile media includes, for example, optical or magnetic disks, such as disk drive 1110. Volatile media includes dynamic memory, such as system memory 1106. Transmission media includes coaxial cables, copper wire, and fiber optics, including wires that comprise bus 1102. Transmission media can also take the form of acoustic or light waves, such as those generated during radio wave and infrared data communications.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, electromagnetic waveforms, or any other medium from which a computer can read.

In some examples, execution of the sequences of instructions can be performed by a single computer system 1100. According to some examples, two or more computer systems 1100 coupled by communication link 1120 (e.g., LAN, PSTN, or wireless network) can perform the sequence of instructions in coordination with one another. Computer system 1100 can transmit and receive messages, data, and instructions, including program code (i.e., application code) through communication link 1120 and communication interface 1112. Received program code can be executed by processor 1104 as it is received, and/or stored in disk drive 1110, or other non-volatile storage for later execution. In one embodiment, system 1100 is implemented as a hand-held device. But in other embodiments, system 1100 can be implemented as a personal computer (i.e., a desktop computer) or any other computing device. In at least one embodiment, any of the above-described delivery systems can be implemented as a single system 1100 or can implemented in a distributed architecture including multiple systems 1100.

In other examples, the systems, as described above can be implemented from a personal computer, a computing device, a mobile device, a mobile telephone, a facsimile device, a personal digital assistant (“PDA”) or other electronic device.

In at least some of the embodiments, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

Alternatively, the elements and their functionality can be subdivided into constituent sub-elements, if any. As software, the above-described techniques can be implemented using various types of programming or formatting languages, frameworks, syntax, applications, protocols, objects, or techniques, including C, Objective C, C++, C#, Flex™, Fireworks®, Java™, Javascript™, AJAX, COBOL, Fortran, ADA, XML, HTML, DHTML, XHTML, HTTP, XMPP, and others. These can be varied and are not limited to the examples or descriptions provided.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. A computer-implemented method for managing online group engagement, comprising:
creating an online group associated with a webinar responsive to an indication by one online user, wherein the online group includes a plurality of online users;
sharing electronic data with the online group via a communication system;
automatically and continuously monitoring, by the communication system, engagement activities of the plurality of online users associated with the electronic data;
analyzing, using machine learning techniques, the monitored engagement activities to determine engagement levels of the plurality of online users with the electronic data, wherein the machine learning techniques evaluate historical engagement data to generate predicted engagement trends;
identifying, using the machine learning techniques, members exhibiting anomalous engagement patterns compared to the predicted engagement trends, wherein known input data is used to gradually adjust a model to more accurately compute already known output, and once trained, field data is applied as input to generate the predicted engagement trends;
displaying statistical data associated with the engagement levels in a graphical user interface (GUI);
automatically modifying members of the online group to form an updated online group based on: the identified members exhibiting anomalous engagement patterns, and the predicted engagement trends,
wherein the electronic data is more tailored and relevant to members of the updated online group in comparison to members of the online group.

2. The computer-implemented method of claim 1, wherein the engagement activities being monitored include at least one or more of:
pins associated with the electronic data,
copy/paste operations associated with the electronic data,
accesses to a uniform resource locator (URL) associated with the electronic data,
accesses to a proxy URL associated with the electronic data,
emails that include content associated with the electronic data,
voice calls associated with the electronic data, and
video conferences associated with the electronic data.

3. The computer-implemented method of claim 1, wherein the statistical data includes a number of online users of the plurality of online users that have accessed the first electronic data.

4. The computer-implemented method of claim 1, further comprising:
determining a duration of time elapsed between when the electronic data was shared and when the electronic data was accessed by each online user of the plurality of online users; and
displaying data associated with the duration of time elapsed between when the electronic data was shared and when the electronic data was accessed by each online user of the plurality of online users.

5. The computer-implemented method of claim 1, further comprising:
transmitting a reminder signal to a subset of online users from the plurality of online users that have not accessed the first electronic data, wherein the reminder signal is transmitted in response to a triggering event.

6. The computer-implemented method of claim 5, wherein the triggering event is a level of importance of the electronic data, wherein the level of importance is determined based on weighted factors associated with a plurality of different activities performed by the plurality of online users with respect to the electronic data or based on a number of times that the electronic data has been accessed being greater than a threshold value.

7. The computer-implemented method of claim 1, further comprising: identifying a subset of online users from the plurality of online users as key members associated with the electronic data based on a weighted factor associated with a content of the electronic data, assignment associated with online users of the plurality of online users as designated by a creator of the online group, and organizational relationship of plurality of online users to the creator of the group.

8. The computer-implemented method of claim 1, wherein automatically modifying members of the online group to form the updated online group, comprises:
identifying a subset of online users from the plurality of online users to be removed from the online group based on the identified members exhibiting the anomalous engagement patterns and the predicted engagement trends; and
removing the subset of online users from the online group.

9. A communication system for managing online group engagement, the communication system comprising:
one or more hardware processors configured to:
create an online group associated with a webinar responsive to an indication by one online user, wherein the online group includes a plurality of online users;
share electronic data with the online group;
automatically and continuously monitor engagement activities of the plurality of online users associated with the electronic data;
analyze, using machine learning techniques, the monitored engagement activities to determine engagement levels of the plurality of online users with the electronic data, wherein the machine learning techniques evaluate historical engagement data to generate predicted engagement trends;
identify, using the machine learning techniques, members exhibiting anomalous engagement patterns compared to the predicted engagement trends, wherein known input data is used to gradually adjust a model to more accurately compute already known output, and once trained, field data is applied as input to generate the predicted engagement trends;
display statistical data associated with the engagement levels in a graphical user interface (GUI);
automatically modify members of the online group to form an updated online group based on: the identified members exhibiting anomalous engagement patterns, and the predicted engagement trends,
wherein the electronic data is more tailored and relevant to members of the updated online group in comparison to members of the online group.

10. The communication system of claim 9, wherein the engagement activities being monitored include at least one or more of:
pins associated with the electronic data,
copy/paste operations associated with the electronic data,
accesses to a uniform resource locator (URL) associated with the electronic data,
accesses to a proxy URL associated with the electronic data,
emails that include content associated with the electronic data,
voice calls associated with the electronic data, and
video conferences associated with the electronic data.

11. The communication system of claim 9, wherein the statistical data includes a number of online users of the plurality of online users that have accessed the first electronic data.

12. The communication system of claim 9, wherein the one or more hardware processors are further configured to:
determine a duration of time elapsed between when the electronic data was shared and when the electronic data was accessed by each online user of the plurality of online users; and
display data associated with the duration of time elapsed between when the electronic data was shared and when the electronic data was accessed by each online user of the plurality of online users.

13. The communication system of claim 9, wherein the one or more hardware processors are further configured to:
transmit a reminder signal to a subset of online users from the plurality of online users that have not accessed the first electronic data, wherein the reminder signal is transmitted in response to a triggering event.

14. The communication system of claim 13, wherein the triggering event is a level of importance of the electronic data, wherein the level of importance is determined based on weighted factors associated with a plurality of different activities performed by the plurality of online users with respect to the electronic data or based on a number of times that the electronic data has been accessed being greater than a threshold value.

15. The communication system of claim 9, wherein the one or more hardware processors are further configured to: identify a subset of online users from the plurality of online users as key members associated with the electronic data based on a weighted factor associated with a content of the electronic data, assignment associated with online users of the plurality of online users as designated by a creator of the online group, and organizational relationship of plurality of online users to the creator of the group.

16. The communication system of claim 9, wherein automatically modifying members of the online group to form the updated online group, comprises:
identifying a subset of online users from the plurality of online users to be removed from the online group based on the identified members exhibiting the anomalous engagement patterns and the predicted engagement trends; and
removing the subset of online users from the online group.

17. A non-transitory computer-readable medium storing program instructions that, when executed by one or more hardware processors of a communication system, cause the communication system to perform operations comprising:
creating an online group associated with a webinar responsive to an indication by one online user, wherein the online group includes a plurality of online users;
sharing electronic data with the online group;
automatically and continuously monitoring engagement activities of the plurality of online users associated with the electronic data;
analyzing, using machine learning techniques, the monitored engagement activities to determine engagement levels of the plurality of online users with the electronic data, wherein the machine learning techniques evaluate historical engagement data to generate predicted engagement trends;
identifying, using the machine learning techniques, members exhibiting anomalous engagement patterns compared to the predicted engagement trends, wherein known input data is used to gradually adjust a model to more accurately compute already known output, and once trained, field data is applied as input to generate the predicted engagement trends;
displaying statistical data associated with the engagement levels in a graphical user interface (GUI);
automatically modifying members of the online group to form an updated online group based on: the identified members exhibiting anomalous engagement patterns, and the predicted engagement trends,
wherein the electronic data is more tailored and relevant to members of the updated online group in comparison to members of the online group.
